(19) United States
(12) Patent Application Publication
(10) Pub. No.: US 2026/0304575 A1
(43) Pub. Date: Oct. 1, 2026

(54) DATA STRUCTURE, ILLUMINATION CONTROL METHOD, AND ILLUMINATION APPARATUS

(71) Applicant: SEIKO EPSON CORPORATION, Tokyo (JP)

(72) Inventor: Jun YOSHIMURA, Bungoono-shi (JP)

(73) Assignee: SEIKO EPSON CORPORATION, Tokyo (JP)

(21) Appl. No.: 19/577,449

(22) Filed: Mar. 25, 2026

(30) Foreign Application Priority Data
Mar. 26, 2025 (JP) 2025-051242

(51) Int. Cl. H05B 47/105

(52) U.S. Cl. CPC H05B 47/105

(57) ABSTRACT

A data structure includes first information including information indicating a plurality of colors different from each other, and n sets of second information associating any one of the plurality of colors indicated by the first information with each of a plurality of light sources of an illumination apparatus, n being an integer of 1 or more.

### CROSS- REFERENCE TO RELATED APPLICATIONS

The present application is based on, and claims priority from JP Application Serial Number 2025-051242, filed Mar. 26, 2025, the disclosure of which is hereby incorporated by reference herein in its entirety.

### BACKGROUND

### 1. Technical Field

The present disclosure relates to a data structure, an illumination control method, and an illumination apparatus.

### 2. Related Art

JP-A-2019-129116 discloses an illumination control apparatus including a storage that stores information indicating each setting range that indicates a range of a parameter corresponding to a plurality of items related to an output of light, and a controller that controls power supplied for a light-emitting module such that an output of light emitted by the light-emitting module is attenuated while repeating bright and dark based on each selection value selected from each setting range.

JP-A-2019-129116 is an example of the related art.

In the apparatus disclosed in JP-A-2019-129116, a control command combining a plurality of parameters is used for a light output curve when the bright and dark are repeated. The use of this control command is limited to a specific lighting mode called a fluctuation mode. Therefore, another control command is required to be designed for other purposes. Under such circumstances, there is a demand for a more versatile light source control technique.

### SUMMARY

A data structure according to an aspect of the disclosure includes: first information including information indicating a plurality of colors different from each other; and n sets of second information associating any one of the plurality of colors indicated by the first information with each of a plurality of light sources of an illumination apparatus, n being an integer of 1 or more.

An illumination control method according to an aspect of the disclosure includes: causing each of a plurality of light sources of an illumination apparatus to emit light based on first information including information indicating a plurality of colors different from each other, and n sets of second information associating any one of the plurality of colors indicated by the first information with each of the plurality of light sources, n being an integer of 1 or more.

An illumination apparatus according to an aspect of the disclosure includes: a plurality of light sources; and a control device configured to cause each of the plurality of light sources to emit light based on first information including information indicating a plurality of colors different from each other, and n sets of second information associating any one of the plurality of colors indicated by the first information with each of the plurality of light sources, n being an integer of 1 or more.

### BRIEF DESCRIPTION OF THE DRAWINGS

FIG. 1 schematically shows a system used for an illumination control method according to a first embodiment.

FIG. 2 is a block diagram of an illumination apparatus and a terminal apparatus according to the first embodiment.

FIG. 3 shows an example of a housing of the illumination apparatus.

FIG. 4 shows a plurality of light sources provided in the housing shown in FIG. 3.

FIG. 5 shows profile information.

FIG. 6 shows a structure example of the profile information.

FIG. 7 shows a header area and a palette area of the profile information.

FIG. 8 shows a data area of the profile information.

FIG. 9 is a flowchart showing a flow of the illumination control method according to the first embodiment.

FIG. 10 shows operation reception and light emission of a plurality of light sources.

FIG. 11 is a block diagram of an illumination apparatus and a terminal apparatus according to a second embodiment.

FIG. 12 shows an example of effect information.

FIG. 13 shows a gain based on eighth information and ninth information.

FIG. 14 shows driving of light sources.

FIG. 15 is a flowchart showing a flow of an illumination control method according to the second embodiment.

### DESCRIPTION OF EMBODIMENTS

Preferred embodiments according to the disclosure will be described below with reference to the accompanying drawings. In the drawings, the dimensions and scales of units are different from actual ones as appropriate, and there may be parts schematically shown in order to facilitate understanding. The scope of the disclosure is not limited to the embodiments unless otherwise specifically stated in the following description.

### 1. First Embodiment

### 1-1. Overview of System

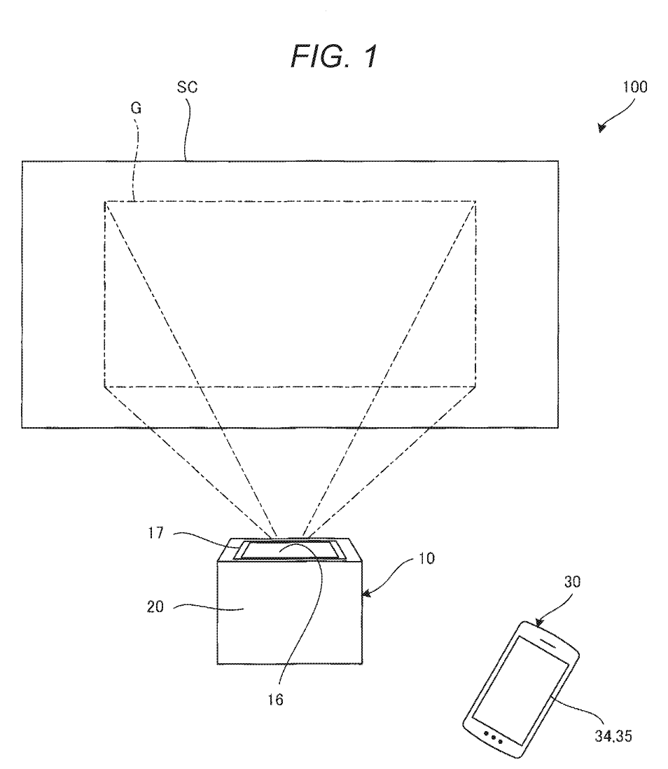

FIG. 1 schematically shows a system 100 used for an illumination control method according to a first embodiment. As shown in FIG. 1, the system 100 includes an illumination apparatus 10 and a terminal apparatus 30.

The illumination apparatus 10 is an apparatus having an illumination function. In the present embodiment, the illumination apparatus 10 has a projection function of projecting an image G on a projection surface SC in addition to the illumination function. The projection surface SC is an object such as a screen or a wall. The projection surface SC is not limited to a planar surface and may be, for example, a curved surface. The projection function is used as necessary and may be omitted. The illumination apparatus 10 may have a function different from the projection function, as a function other than the illumination function.

The illumination apparatus 10 includes a housing 20, and an input device 16 and an illuminator 17 are disposed in the housing 20. As will be described in detail later, the illumination apparatus 10 causes a plurality of light sources 17a to be described later of the illuminator 17 to emit light in a light emission pattern and a light emission color based on profile information DP1 or profile information DP2 to be described later. In addition, the illumination apparatus 10 switches between the profile information DP1 and the profile information DP2 based on an input result of the input device 16 and applies the control information to light emission of the plurality of light sources 17a to be described later.

The terminal apparatus 30 is an apparatus communicably connected to the illumination apparatus 10, and has a function of controlling an operation of the illumination apparatus 10 and a function of changing a setting of the illumination apparatus 10. More specifically, the terminal apparatus 30 generates the profile information DP1 and DP2 to be described later, and transmits the generated profile information DP1 and DP2 to the illumination apparatus 10.

In the shown example, the terminal apparatus 30 is a smartphone. The terminal apparatus 30 is not limited to the smartphone and may be, for example, a notebook or desktop computer, or a tablet terminal.

### 1-2. Illumination Apparatus and Terminal Apparatus

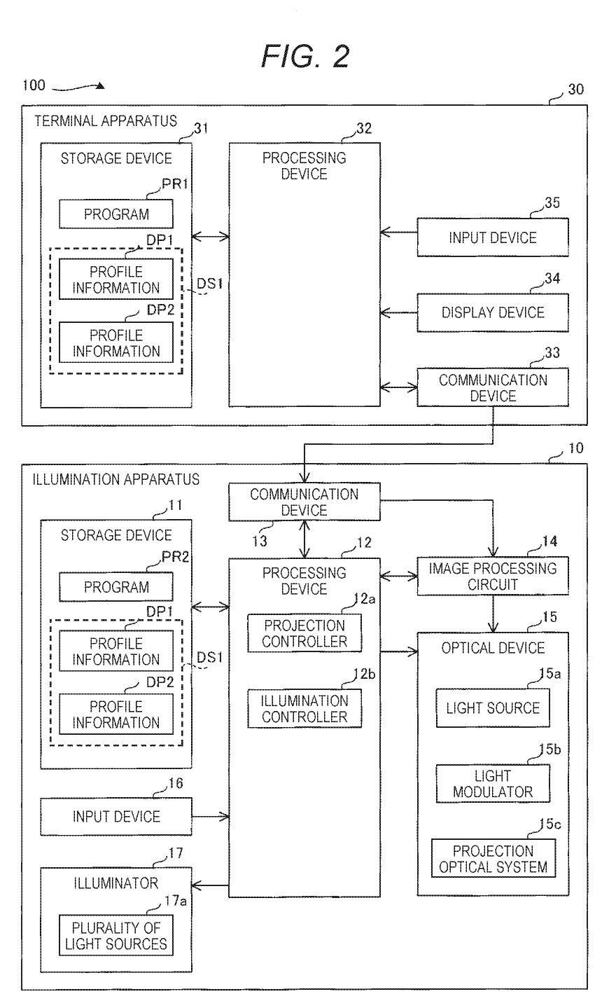

FIG. 2 is a block diagram of the illumination apparatus 10 and the terminal apparatus 30 according to the first embodiment. As shown in FIG. 2, the illumination apparatus 10 includes a storage device 11, a processing device 12, a communication device 13, an image processing circuit 14, an optical device 15, the input device 16, and the illuminator 17. These devices are communicably connected to each other. The processing device 12 is an example of a "control device". When the illumination apparatus 10 does not have the projection function, the image processing circuit 14 and the optical device 15 may be omitted.

The storage device 11 is a storage device that stores a program to be executed by the processing device 12 and data to be processed by the processing device 12. The storage device 11 includes, for example, a hard disk drive or a semiconductor memory. A part or all of the storage device 11 may be provided in a storage device, a server, or the like outside the illumination apparatus 10.

The storage device 11 stores a program PR2 and a data structure DS1.

The program PR2 is a program for executing an illumination control method to be described later together with a program PR1 to be described later.

The data structure DS1 includes a first set of profile information DP1 and a second set of profile information DP2.

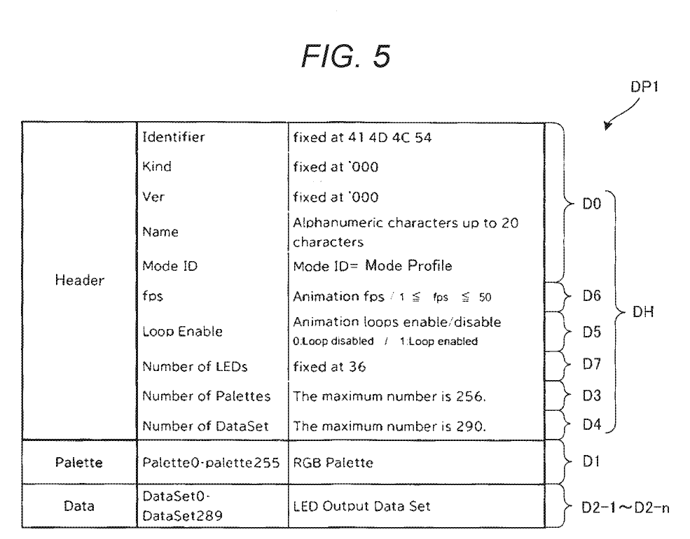

Each piece of the profile information DP1 and DP2 is information indicating a change over time in the light emission pattern and the light emission color of the plurality of light sources 17a, and includes first information D1 and second information D2 to be described later. However, the second set of profile information DP2 is different from the first set of profile information DP1 in at least a part of the first information D1 and the second information D2. Accordingly, changes over time in the light emission pattern and the light emission color indicated by the profile information DP1 and DP2 are different from each other. Details of the data structure DS1 will be described later with reference to FIGS. 5 to 8. The light emission pattern is a temporal pattern of a combination of lighting and extinguishing of each of the plurality of light sources 17a. The light emission pattern may be referred to as a pattern of lighting and blinking of the plurality of light sources 17a. The light emission pattern corresponds to a time-series change in a tone value of the plurality of light sources 17a determined based on the profile information DP1 and DP2 to be described later. In addition, the light emission pattern may include a time-series change in the tone value of the plurality of light sources 17a based on effect information DE1 and DE2 of a second embodiment to be described later.

As will be described in detail later, in the embodiment, each piece of the profile information DP1 and DP2 includes identification information D0, third information D3, fourth information D4, fifth information D5, sixth information D6, and seventh information D7 in addition to the first information D1 and the second information D2. However, the profile information DP1 and the profile information DP2 are different from each other in at least a part of data in the first information D1 and the second information D2. In the embodiment, an aspect will be described in which two pieces of profile information, that is, DP1 and DP2 are used, but the disclosure is not limited to this aspect, and the number of pieces of profile information is any number and may be one or three or more.

The processing device 12 is a processing device having a function of controlling each part of the illumination apparatus 10 and a function of processing various data. The processing device 12 includes at least one processor such as a central processing unit (CPU). The processing device 12 may include a single processor or may include a plurality of processors. A part or all of the functions of the processing device 12 may be implemented by hardware such as a digital signal processor (DSP), an application-specific integrated circuit (ASIC), a programmable logic device (PLD), or a field-programmable gate array (FPGA). The processing device 12 may be integrated with the image processing circuit 14.

The communication device 13 is a communication device that can communicate with various devices, and communicates with the terminal apparatus 30 and acquires video data from a device that is not shown. The communication device 13 is a wireless communication device such as low power wide area (LPWA), a wireless LAN including Wi-Fi, or Bluetooth. "Wi-Fi" and "Bluetooth" are registered trademarks. The communication device 13 is not limited to the wireless communication device and may be a wired communication device such as a wired local area network (LAN), a universal serial bus (USB), or a high-definition multimedia interface (HDMI). "HDMI" is a registered trademark.

The image processing circuit 14 is a circuit that performs required processing on video data from the communication device 13 and inputs the processed video data to the optical device 15. The image processing circuit 14 includes, for example, a frame memory (not shown), loads the video data in the frame memory, executes various types of processing such as resolution conversion processing, resizing processing, and distortion correction processing as appropriate, and inputs the processed video data to the optical device 15. The image processing circuit 14 may execute, as necessary, processing such as on-screen display (OSD) processing of generating image information for a menu display, an operation guide, or the like and combining the image information with the video data.

The optical device 15 is a device that projects image light onto the projection surface SC. The optical device 15 includes a light source 15a, a light modulator 15b, and a projection optical system 15c.

The light source 15a includes a light source such as a halogen lamp, a xenon lamp, an ultrahigh-pressure mercury lamp, a light-emitting diode (LED), or a laser light source, and outputs red light, green light, and blue light. The light modulator 15b draws an image based on video data supplied from the terminal apparatus 30. The light modulator 15b includes three light modulation elements provided to correspond to red, green, and blue. The light modulation elements include, for example, transmissive liquid crystal panels, reflective liquid crystal panels, or digital mirror devices (DMDs) and modulate light of corresponding colors to generate image light of each color. The image light of each color generated by the light modulator 15b is combined by a color combining optical system to become full color image light. The projection optical system 15c is an optical system including a projection lens and the like that form an image of the full color image light from the light modulator 15b and projects the image onto the projection surface SC. The image drawn by the light modulator 15b, that is, a drawn image is projected onto the projection surface SC via the projection lens.

The input device 16 is a device that receives an operation from a user. In the embodiment, the input device 16 is a touch sensor. The input device 16 is not limited to the touch sensor and may be, for example, a proximity sensor, a button switch, or a slide bar.

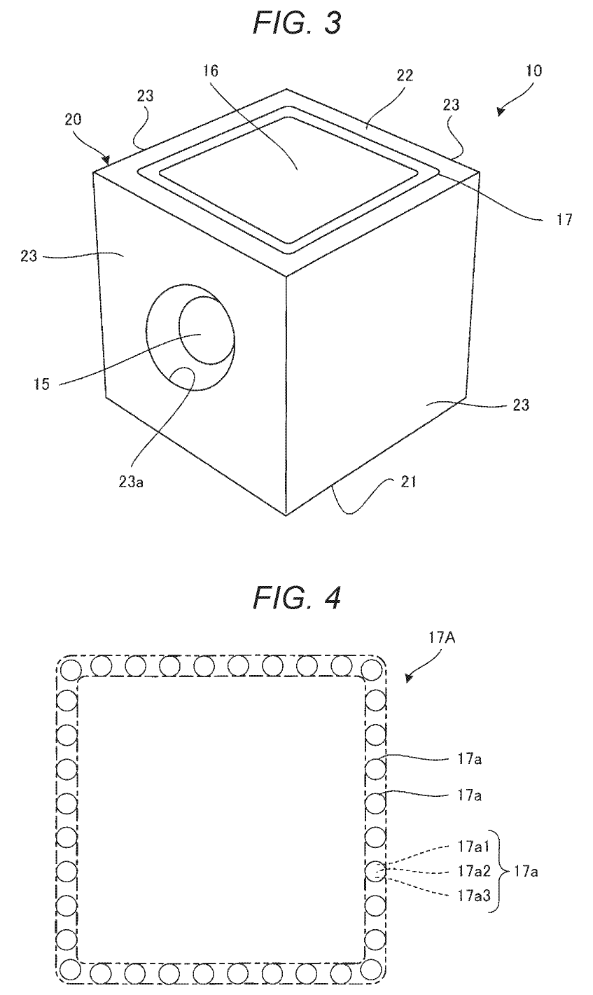

The illuminator 17 includes the plurality of light sources 17a. Each light source 17a is, for example, a light-emitting element such as a full color LED element that can change the light emission color and a brightness, and can change a luminance ratio of red light emission, green light emission, and blue light emission. Disposition of the plurality of light sources 17a will be described later with reference to FIGS. 3 and 4. In addition to the light-emitting element, the illuminator 17 may also include a drive circuit that drives the light-emitting element, or the like.

In the illumination apparatus 10 described above, the processing device 12 executes the program PR2 stored in the storage device 11 and thus functions as a projection controller 12a and an illumination controller 12b. Therefore, the processing device 12 includes the projection controller 12a and the illumination controller 12b.

The projection controller 12a controls operations of the image processing circuit 14 and the optical device 15. More specifically, the projection controller 12a controls the operations of the image processing circuit 14 and the optical device 15 to project the image G onto the projection surface SC.

The illumination controller 12b controls driving of the illuminator 17. More specifically, the illumination controller 12b acquires the profile information DP1 and DP2 in the data structure DS1 from the terminal apparatus 30 via the communication device 13, and stores the acquired profile information DP1 and DP2 in the storage device 11. In addition, based on the input result of the input device 16, the illumination controller 12b controls a light emission state such as the brightness, the light emission pattern, or the light emission color of the illuminator 17 to a light emission state based on the profile information DP1 or the profile information DP2.

In this way, the processing device 12 causes each of the plurality of light sources 17a to emit light based on the first information D1 and the second information D2, which will be described later, in the profile information DP1 or the profile information DP2, and thus it is possible to implement highly versatile control of the light sources 17a corresponding to various lighting modes.

Meanwhile, as shown in FIG. 2, the terminal apparatus 30 includes a storage device 31, a processing device 32, a communication device 33, a display device 34, and an input device 35. These devices are communicably connected to each other.

The storage device 31 is a storage device that stores programs such as an operating system and application programs to be executed by the processing device 32 and data to be processed by the processing device 32. The storage device 31 includes, for example, a hard disk drive or a semiconductor memory. A part or the entire storage device 31 may be a storage device outside the terminal apparatus 30 or may be provided in an external device such as a server connected to the terminal apparatus 30 via a communication network such as the Internet.

The storage device 31 stores the program PR1 and the data structure DS1.

The program PR1 is a program for executing the illumination control method to be described later, together with the program PR2 described above.

The processing device 32 is a processing device having a function of controlling the units of the terminal apparatus 30 and a function of processing various data. The processing device 32 includes a processor such as a CPU. The processing device 32 may include a single processor or may include a plurality of processors. A part or all of the functions of the processing device 32 may be implemented by hardware such as a DSP, an ASIC, a PLD, or an FPGA.

The communication device 33 is a communication device that can communicate with the illumination apparatus 10 and the like. The communication device 33 is a wireless communication device such as LPWA, a wireless LAN including Wi-Fi, or Bluetooth. "Wi-Fi" and "Bluetooth" are registered trademarks. The communication device 33 may be a wired communication device such as a wired LAN, a USB, or an HDMI. "HDMI" is a registered trademark. The communication device 33 may be communicable with an apparatus other than the illumination apparatus 10.

The display device 34 displays various images under control by the processing device 32. The display device 34 is a display device including various display panels such as a liquid crystal display panel and an organic EL display panel.

The input device 35 is an input device that receives an operation from the user. For example, the input device 35 includes a pointing device such as a touch pad, a touch panel, or a mouse. When the input device 35 includes the touch panel, the input device 35 may also serve as the display device 34.

In the terminal apparatus 30 described above, the processing device 32 executes the program PR1 stored in the storage device 31 and thus implements various functions required for the illumination control method to be described later. More specifically, the processing device 32 displays, on the display device 34, an image used for controlling and setting the illuminator 17, generates the data structure DS1 based on an input result of the input device 35 using the image, and causes the communication device 33 to transmit the data structure DS1 to the illumination apparatus 10.

### 1-3. Plurality of Light Sources

FIG. 3 shows an example of the housing 20 of the illumination apparatus 10. In the example shown in FIG. 3, the housing 20 has a cubic shape having a bottom surface 21, a top surface 22, and four side surfaces 23. The input device 16, which is a touch sensor, and the illuminator 17 are provided at the top surface 22. One side surface 23 among the four side surfaces 23 is provided with an opening 23a for allowing projection from the optical device 15.

The illuminator 17 has an annular shape that surrounds a periphery of the input device 16 along an outer peripheral edge of the top surface 22. The shape of the housing 20 is not limited to the shown example and is set as desired. In addition, aspects such as disposition, shape, and number of the illuminator 17 are not limited to the shown example and are set as desired.

FIG. 4 shows the plurality of light sources 17a provided in the housing 20 shown in FIG. 3. As shown in FIG. 4, the illuminator 17 includes the plurality of light sources 17a arranged along an annular shape. In the shown example, the number of light sources 17a provided in the illuminator 17 is 36. The number of light sources 17a provided in the illuminator 17 is not limited to the shown example and is set as desired.

Each light source 17a includes light-emitting elements 17a1, 17a2, 17a3. The light-emitting element 17a1 is an example of a "first light-emitting element" and emits light having a first wavelength. The light-emitting element 17a2 is an example of a "second light-emitting element" and emits light having a second wavelength different from the first wavelength. The light-emitting element 17a3 is an example of a "third light-emitting element" and emits light having a third wavelength different from the first wavelength and the second wavelength. For example, the light-emitting element 17a1 emits red light, the light-emitting element 17a2 emits green light, and the light-emitting element 17a3 emits blue light. By changing a balance among light emission intensities of the light-emitting elements 17a1, 17a2, and 17a3, each light source 17a can be caused to emit light in full color.

The number of light-emitting elements in each light source 17a may be two or less or four or more. The plurality of light-emitting elements in each light source 17a may include a plurality of light-emitting elements that emit light of the same wavelength.

The plurality of light sources 17a provided in the illuminator 17 described above can individually control the light emission color and the brightness. Accordingly, the light emission pattern and the light emission color of the plurality of light sources 17a in the illuminator 17 can be variously changed.

In the related art, since an effect based on a change over time in the light emission pattern and the light emission color of the plurality of light sources 17a is performed by programming, it is required to change a program in order to change or customize the effect. Since it is required to change the program after understanding an internal structure thereof, there is a problem that cost increases. In addition, firmware is required to be updated to change the program.

Therefore, in the illumination apparatus 10, effect content is defined in a predetermined structure as the data structure DS1. Accordingly, the effect can be changed or customized by changing data according to a definition. That is, the illumination apparatus 10 causes the plurality of light sources 17a in the illuminator 17 to emit light in the light emission pattern and the light emission color based on the profile information DP1 or the profile information DP2. The method using the data structure DS1 can implement various effects by changing the data without changing the program each time, and thus has higher versatility than a method of performing the effect by programming.

### 1-4. Profile Information

FIG. 5 shows the profile information DP1. The profile information DP1 is defined as binary data, for example, as shown in FIG. 5. Accordingly, a predetermined structure is defined by fixing a disposition address and a size. Hereinafter, the profile information DP1 when each light source 17a includes three light-emitting elements 17a1, 17a2, 17a3 that emit red light, green light, and blue light is shown as an example.

The profile information DP1 and the profile information DP2 have the same data structure. Therefore, hereinafter, the profile information DP1 will be representatively described, and a detailed description of the profile information DP2 will be omitted. In addition, the data structure of the profile information DP1 is not limited to the following form shown as an example, and for example, an arrangement order or the number of items may be appropriately changed, or an item that is not shown may be added. In addition, a free area may be used to add an item. In addition, the profile information DP1 may be divided into a plurality of units. In addition, shown numerical values or memory addresses are both examples, and can be changed as desired.

Specifically, the profile information DP1 of the data structure DS1 includes the identification information D0, the first information D1, second information D2-1 to D2-n, the third information D3, the fourth information D4, the fifth information D5, the sixth information D6, and the seventh information. Here, n is an integer of 1 or more. Hereinafter, each piece of the second information D2-1 to D2-n may be referred to as the second information D2 without distinction. The second information D2-1 to D2-n may be referred to as n sets of second information D2. Further, second information D2-k may be referred to as a k-th set of second information D2. Here, k is an integer of 1 or more and n or less.

Here, as shown in FIG. 5, the profile information DP1 is divided into a header area, a palette area, and a data area. The header area includes header information DH. The header information DH includes the identification information D0, the third information D3, the fourth information D4, the fifth information D5, the sixth information D6, and the seventh information. The palette area includes the first information D1. The data area includes the second information D2-1 to D2-n.

The identification information D0 is information for identifying the profile information DP1 from other profile information. In the shown example, the identification information D0 includes information indicating an identifier (Identifier), a type (Kind), a version (Ver), a name (Name), and a mode ID (Mode ID). The information indicating the identifier, the type, and the version has a fixed value in the embodiment and may be changeable. An item having a fixed value may be omitted. When there is only one set of profile information, the identification information D0 may be omitted.

The first information D1 is color information including information indicating a plurality of different colors. In the shown example, the first information D1 includes information indicating a palette (RGB palette) that can represent 256 tones of the brightness for each of red (R), green (G), and blue (B). The first information D1 in the profile information DP1 is an example of a "first set of the first information" and the first information D1 in the profile information DP2 is an example of a "second set of the first information".

Each piece of the second information D2 is display information indicating the light emission pattern and the light emission color of the plurality of light sources 17a of the illumination apparatus 10. The n sets of second information D2 associate one of the plurality of colors indicated by the first information D1 with each of the plurality of light sources 17a of the illumination apparatus 10. In the shown example, n = 290, and the n sets of second information D2 are 290 data sets (Data Set0 to Data Set289).

The third information D3 is information indicating the number of colors in the first information D1 and indicates the number of palettes (Number of Palettes). Accordingly, the number of colors in the first information D1 can be easily determined based on the third information D3.

The fourth information D4 is information indicating a value of n and indicates the number of data sets (Number of DataSet). Accordingly, the value of n can be easily determined based on the fourth information D4. That is, the number of pieces of second information D2 can be easily determined based on the fourth information D4.

The fifth information D5 is information indicating whether to repeatedly execute processing of reading the n sets of second information D2 in order from a first set to an n-th set, and indicates whether a loop is enabled (Loop Enable). Accordingly, it is possible to determine whether the processing of reading the n sets of second information D2 is repeated based on the fifth information D5. When the loop is enabled, an effect using the n sets of second information D2 can be repeated.

The sixth information D6 is information indicating the number of sets of second information D2 to be applied per unit time among the n pieces of second information D2, and indicates a frame per second (fps) as an example. Accordingly, the number of sets of the second information D2 to be applied per unit time can be determined based on the sixth information D6. Here, the number of sets of the second information D2 applied per unit time is an indicator of fps that is the number of frames updated per second. For example, at 5 fps, the plurality of light sources 17a emit light in a light emission pattern for five frames per second. The unit time is not limited to one second and is set as desired. For example, the unit time may be five seconds, ten seconds, or one minute.

The seventh information D7 is information indicating the number of the plurality of light sources 17a (Number of LEDs). Accordingly, the number of the plurality of light sources 17a can be determined based on the seventh information D7.

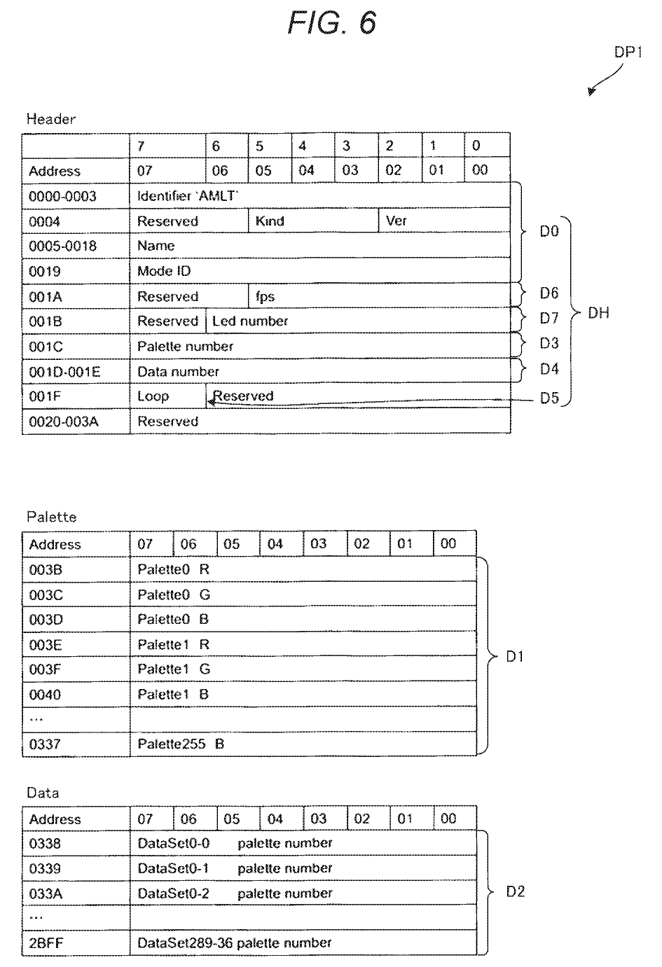

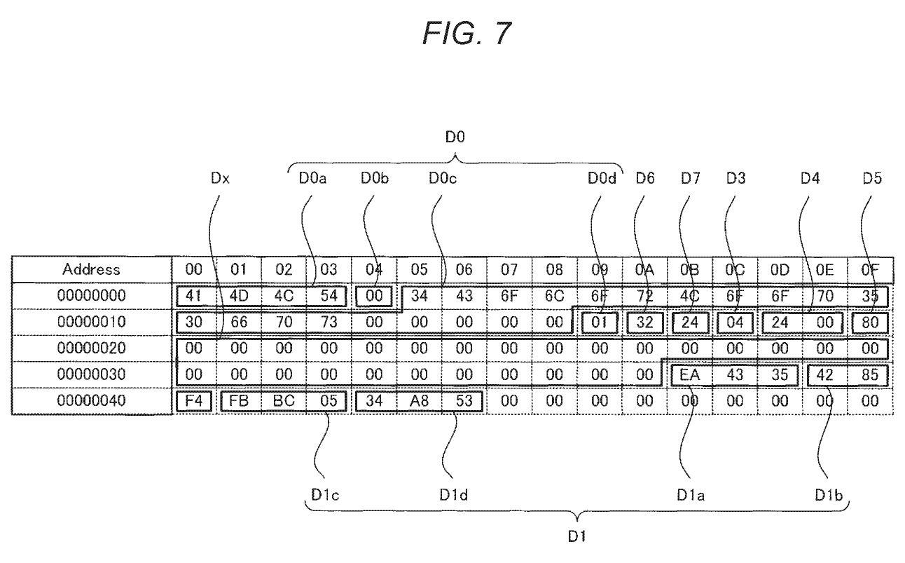

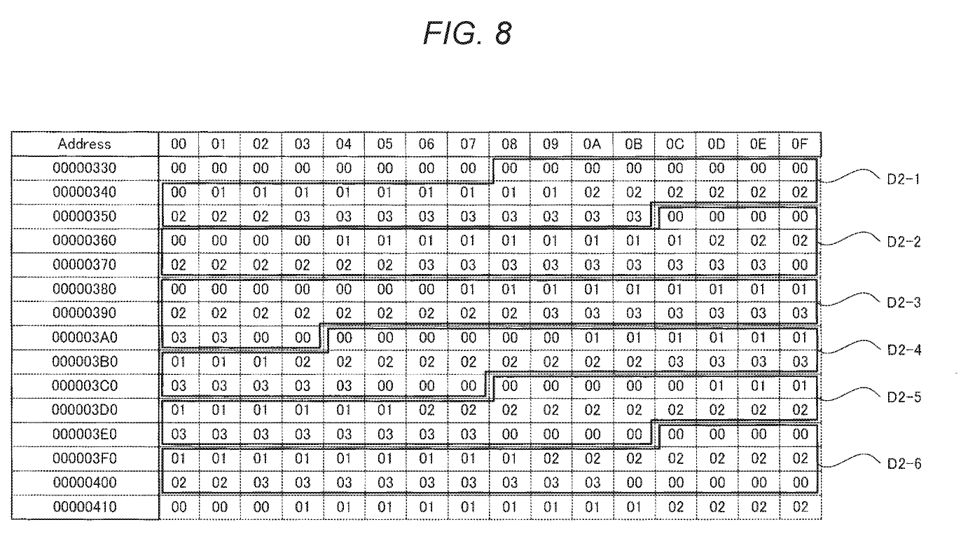

FIG. 6 shows a structure example of the profile information DP1. In FIG. 6, a structure example of the header area is shown in an upper part in the drawing, a structure example of the palette area is shown in a middle part in the drawing, and a structure example of the data area is shown in a lower part in the drawing. FIG. 7 shows the header area and the palette area of the profile information DP1. FIG. 8 shows the data area of the profile information DP1.

As shown in the upper part in FIGS. 6 and 7, the identification information D0 is stored at addresses 0000 to 0019. Here, the identification information D0 includes information D0a indicating the identifier, information D0b indicating the type and the version, information D0c indicating the name, and information D0d indicating the mode ID. These pieces of information are stored in order of the information D0a, the information D0b, the information D0c, and the information D0d. In the shown example, the information D0a is stored at the addresses 0000 to 0003. The information D0b is stored at the address 0004. The information D0c is stored at the addresses 0005 to 0018. The information D0d is stored at the address 0019.

The third information D3, the fourth information D4, the fifth information D5, the sixth information D6, and the seventh information D7 are stored in order of the sixth information D6, the seventh information D7, the third information D3, the fourth information D4, and the fifth information D5. In the shown example, the sixth information D6 is stored at an address 001A. The seventh information D7 is stored at an address 001B. The third information D3 is stored at an address 001C. The fourth information D4 is stored at addresses 001D and 001E. The fifth information D5 is stored at an address 001F. Addresses 0020 to 003A are a free area Dx.

As shown in the middle part in FIG. 6, the first information D1 is stored at addresses 003B to 0337. Here, the first information D1 represents one color by three consecutive addresses. Specifically, the three consecutive addresses represent tone values of R, G, and B in order. Therefore, the first information D1 includes information (Palette(x) R, Palette(x) G, and Palette(x) B) corresponding to the light-emitting elements 17a1, 17a2, and 17a3 of any light source 17a. Here, x of Palette(x) is a palette number, and is an integer from 0 to 255 in the shown example. In FIG. 7, among 256 sets of information constituting such first information D1, four sets of information D1a, D1b, D1c, and D1d are representatively shown. The tone value may be 0. When the tone value of each of R, G, and B is 0, the light source 17a may be in an extinguished state.

Here, in the middle part in FIG. 6, "palette0 R" to "palette255 R" are information indicating a brightness of the light-emitting element 17a1, "palette0 G" to "palette255 G" are information indicating a brightness of the light-emitting element 17a2, and "palette0 B" to "palette255 B" are information indicating a brightness of the light-emitting element 17a3.

In this way, the first information D1 includes, for each of the plurality of light sources 17a, the information indicating the brightness of the light-emitting element 17a1, the information indicating the brightness of the light-emitting element 17a2, and the information indicating the brightness of the light-emitting element 17a3. A combination with these pieces of information indicates one of the plurality of colors indicated by the first information D1. Accordingly, the light emission color of each light source 17a can be changed. Here, the information indicating the brightness of the light-emitting element 17a1 is an example of "first brightness information". The information indicating the brightness of the light-emitting element 17a2 is an example of "second brightness information".

As shown in the lower part in FIG. 6, the n sets of second information D2 are stored at addresses 0338 to 2BFF. Here, the n sets of second information D2, that is, the second information D2-1 to D2-n are stored in time-series order of applications to the plurality of light sources 17a. Specifically, each set of second information D2-1 shown in FIG. 8 includes 36 pieces of data. The processing device 12 refers to the seventh information D7 to read the 36 pieces of data that is the number of light sources 17a indicated in the seventh information D7, and applies the read data to each of the 36 light sources 17a in order from the beginning. By executing such processing in order from the first set, the n sets of second information D2 are applied to the plurality of light sources 17a in order. A time length for applying one set of second information D2 is determined based on the sixth information. In addition, each piece of the second information D2 includes a plurality of pieces of information corresponding to each of the plurality of light sources 17a, and each of the plurality of pieces of information indicates a correspondence relationship between the color indicated by the first information D1 and each light source 17a. In FIG. 8, among the second information D2-1 to D2-n, the second information D2-1 to D2-6 are representatively shown. As an example, since nine pieces of data from the beginning of the first set of second information D2-1 are "00", the processing device 12 causes, by referring to Palette(0) that is a first piece of data in the first information D1, first to ninth light sources 17a among the plurality of light sources 17a to emit light in a color indicated by Palette(0). Similarly, the processing device causes tenth to eighteenth light sources 17a to emit light in a color indicated by Palette(1), causes nineteenth to twenty-seventh light sources 17a to emit light in a color indicated by Palette(2), and causes twenty-eighth to thirty-sixth light sources 17a to emit light in a color indicated by Palette(3).

In this way, in the embodiment, an (m + 1)-th set of second information D2 among the n sets of second information D2 is stored in a data area read subsequently to an m-th set of second information D2, where n is 2 or more and m is an integer of 1 or more and n - 1 or less. Accordingly, the n sets of second information D2 can be read in order from the first set of second information D2 to the n-th set of second information D2. As a result, it is possible to smoothly execute light emission control of the light sources 17a using the n sets of second information D2 in order from the first set of second information D2 to the n-th set of second information D2.

Here, the m-th set of second information D2 is used for light emission of the plurality of light sources 17a in an m-th period, and the (m + 1)-th set of second information D2 is used for light emission of the plurality of light sources 17a in an (m + 1)-th period different from the m-th period. In the embodiment, the (m + 1)-th period is a period after the m-th period. For example, the first set of second information D2 is used for light emission of the plurality of light sources 17a in a first period, and the second set is used for light emission of the plurality of light sources 17a in a second period after the first period. A length of the m-th period and a length of the (m + 1)-th period may be different from each other, and are preferably equal to each other. Accordingly, each period can correspond to a control cycle, and as a result, the light emission control of the plurality of light sources 17a can be suitably performed.

The number of the plurality of light sources 17a corresponds to a delimiter position of the second information D2. That is, it can be said that the seventh information D7 is information indicating the delimiter position of the second information D2. The delimiter position of the second information D2 is a delimiter position between the m-th set of second information D2 and the (m + 1)-th set of second information D2.

As described above, the n sets of second information D2 are information that associates each of the plurality of light sources 17a with one of the plurality of colors indicated by the first information D1. In this way, since the data structure DS includes the first information D1 and the second information D2, it is possible to implement highly versatile control of the light sources 17a corresponding to various lighting modes.

### 1-5. Illumination Control Method

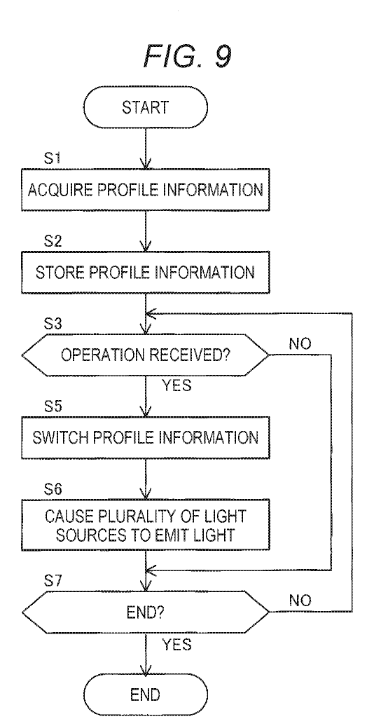

FIG. 9 is a flowchart showing a flow of the illumination control method according to the first embodiment. The illumination control method shown in FIG. 9 includes steps S1 to S7. These steps are executed by the processing device 12. That is, the processing device 12 executes steps S1 to S7.

Specifically, first, in step S1, the processing device 12 acquires the profile information DP1 and DP2. More specifically, in step S1, the processing device 12 functioning as the illumination controller 12b acquires the profile information DP1 and DP2 by receiving the profile information DP1 and DP2 from the terminal apparatus 30 via the communication device 13.

After step S1, in step S2, the processing device 12 stores the profile information DP1 and DP2. More specifically, in step S2, the processing device 12 functioning as the illumination controller 12b stores the received profile information DP1 and DP2 in the storage device 11.

After step S2, in step S3, the processing device 12 determines whether the input device 16 receives an operation. More specifically, in step S3, the processing device 12 functioning as the illumination controller 12b determines whether a predetermined operation is performed on the input device 16. The predetermined operation is an operation associated with the light emission of the plurality of light sources 17a.

When the input device 16 receives the operation (step S3: YES), in step S5, the processing device 12 functioning as the illumination controller 12b switches the profile information applied to the light emission of the plurality of light sources 17a from one of the profile information DP1 and the profile information DP2 to the other, and then, in step S6, causes the plurality of light sources 17a to emit light in the light emission pattern and the light emission color based on the profile information DP1 or the profile information DP2. When a first operation is received in step S5 (step S5: Yes), as an example, the profile information DP1 is applied, and for second and subsequent operations, toggle control is performed to switch from currently applied one of the profile information DP1 or the profile information DP2 to the other one of the profile information DP1 or the profile information DP2 each time the operation is received. Here, the profile information DP1 or the profile information DP2 to be applied is read into the processing device 12 according to the data structure described above.

After step S6 or when the input device 16 does not receive the operation (step S3: NO), in step S7, the processing device 12 determines whether to end the processing. Such determination is performed based on, for example, a user operation on the terminal apparatus 30 or the input device 16.

When the processing is not to be ended (step S7: NO), the processing device 12 functioning as the illumination controller 12b proceeds to step S3 described above. Accordingly, among steps S3 to S6 described above, the step corresponding to the operation on the input device 16 is repeatedly executed.

When the processing is to be ended (step S7: YES), the processing device 12 functioning as the illumination controller 12b ends the processing.

### 1-6. Light Emission of Plurality of Light Sources

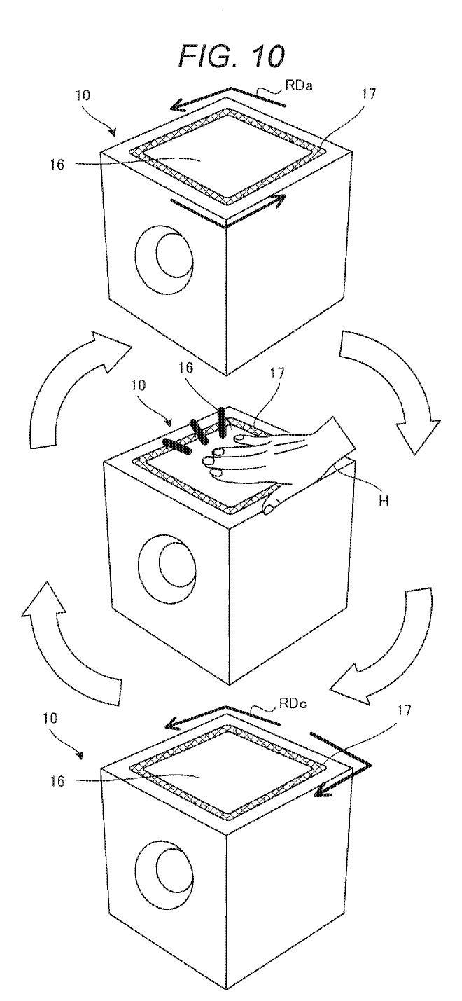

FIG. 10 shows operation reception in step S3 and light emission of the plurality of light sources 17a in step S6. At the center in FIG. 10, the illumination apparatus 10 before receiving the operation on the input device 16 is shown. On an upper side in FIG. 10, the illumination apparatus 10 that causes the illuminator 17 to emit light in the light emission pattern and the light emission color based on the profile information DP1 after the operation on the input device 16 is received is shown. On a lower side in FIG. 10, the illumination apparatus 10 that causes the illuminator 17 to emit light in the light emission pattern and the light emission color based on the profile information DP2 after the operation on the input device 16 is received is shown. In FIG. 10, the illuminator 17 in a light emitting state is shaded.

As shown in FIG. 10, when the predetermined operation is performed on the input device 16 (step S3: YES), a state in which the illuminator 17 is caused to emit light in the light emission pattern and the light emission color based on the profile information DP1 and a state in which the illuminator 17 is caused to emit light in the light emission pattern and the light emission color based on the profile information DP2 are alternately switched (steps S5 and S6). In the example shown in FIG. 10, the predetermined operation is a long press touch operation by a hand H.

Here, in the example shown on the upper side in FIG. 10, bright and dark or the light emission color of the illuminator 17 changes to move along a peripheral direction RDa of the illumination apparatus 10. In the example shown on the lower side in FIG. 10, the bright and dark or the light emission color of the illuminator 17 changes to move along a direction RDc toward the front of the illumination apparatus 10. An aspect of the change in the light emission pattern and the light emission color of the illuminator 17 is not limited to the shown example, and is set as desired.

The predetermined operation in step S3 is not limited to the shown example, and, for example, when the input device 16 is a touch sensor that detects contact, the predetermined operation may be any one of a long press, a short press, a single tap, a double tap, a pinch operation, an operation of drawing a circle, scrolling in a first direction, and scrolling in a second direction different from the first direction on the touch sensor.

In the illumination control method described above, since each of the plurality of light sources 17a is caused to emit light based on the first information D1 and the n sets of second information D2, it is possible to implement highly versatile control of the light sources 17a corresponding to various lighting modes.

### 2. Second Embodiment

A second embodiment of the disclosure will hereinafter be described. Hereinafter, differences from the first embodiment will be mainly described, and descriptions of the same matters as those in the first embodiment will be omitted.

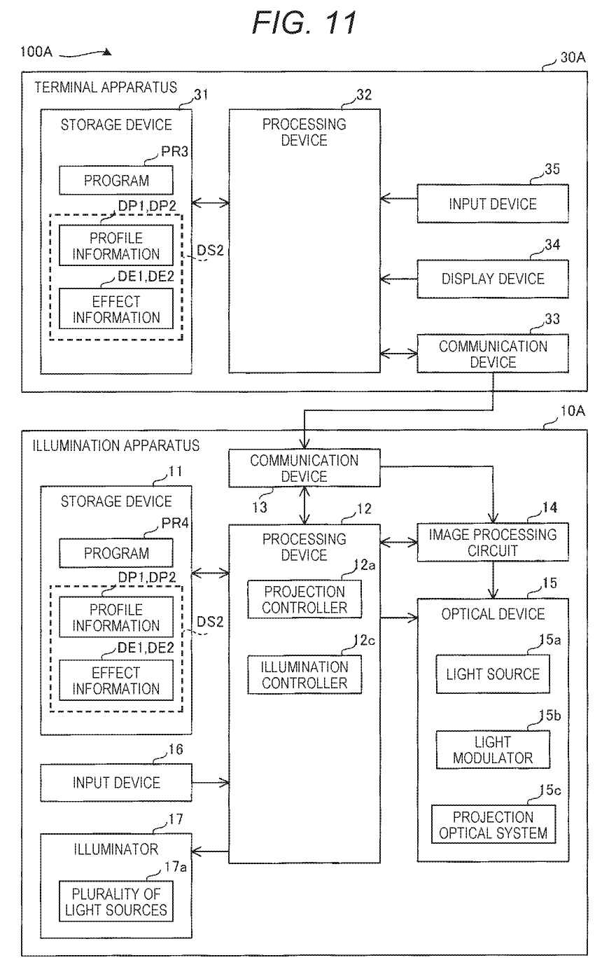

FIG. 11 is a block diagram of an illumination apparatus 10A and a terminal apparatus 30A according to the second embodiment. A system 100A shown in FIG. 11 includes the illumination apparatus 10A and the terminal apparatus 30A instead of the illumination apparatus 10 and the terminal apparatus 30 of the first embodiment.

The illumination apparatus 10A is the same as the illumination apparatus 10 of the first embodiment except that a program PR4 and a data structure DS2 are used instead of the program PR2 and the data structure DS1 of the first embodiment.

The data structure DS2 is the same as the data structure DS1 of the first embodiment except that effect information DE1 and DE2 are added. Each of the effect information DE1 and DE2 is information for adjusting the brightness of the plurality of light sources 17a. However, the effect information DE1 and DE2 indicate different brightness adjustments.

In the illumination apparatus 10A, the processing device 12 executes the program PR4 stored in the storage device 11 and thus functions as the projection controller 12a and an illumination controller 12c.

The illumination controller 12c acquires the data structure DS2 from the terminal apparatus 30 via the communication device 13 and causes the storage device 11 to store the acquired data structure DS2. In addition, based on the input result of the input device 16, the illumination controller 12c controls the light emission state such as the brightness, the light emission pattern, or the light emission color of the illuminator 17 to a light emission state based on a combination of the profile information DP1 or the profile information DP2 and the effect information DE1 or the effect information DE2.

The terminal apparatus 30A is the same as the terminal apparatus 30 of the first embodiment except that a program PR3 and the data structure DS2 are used instead of the program PR1 and the data structure DS1 of the first embodiment.

In the terminal apparatus 30A, the processing device 32 executes the program PR3 stored in the storage device 31 and thus implements various functions required for an illumination control method to be described later. More specifically, the processing device 32 displays, on the display device 34, an image used for controlling and setting the illuminator 17, generates the data structure DS2 based on the input result of the input device 35 using the image, and causes the communication device 33 to transmit the data structure DS2 to the illumination apparatus 10A.

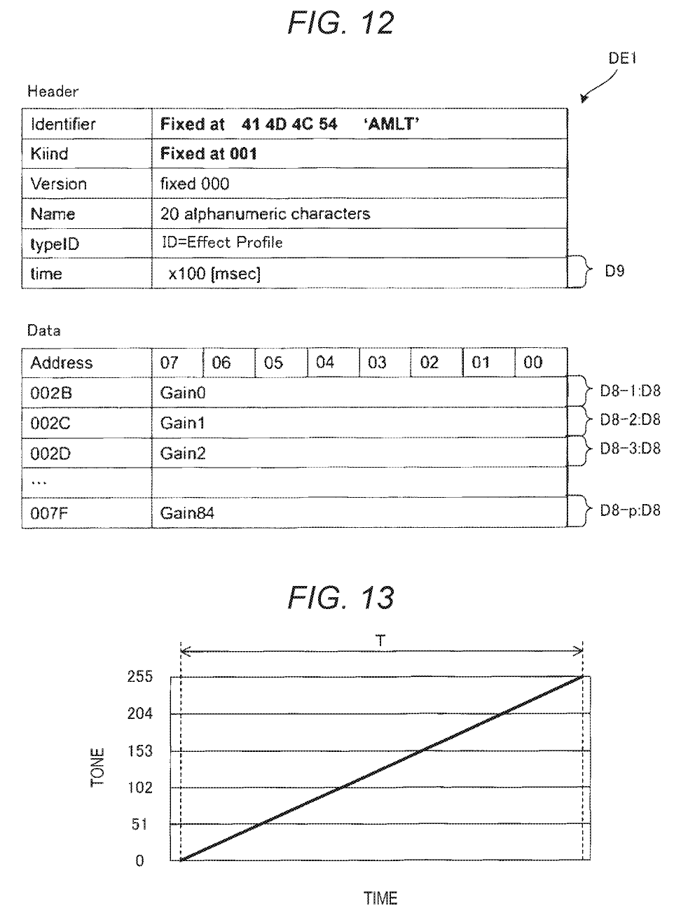

FIG. 12 shows an example of the effect information DE1. As shown in FIG. 12, the effect information DE1 includes a header area and a data area, and the header area includes p sets of eighth information D8-1 to D8-p and ninth information D9. Here, p is an integer of 1 or more. Hereinafter, each piece of the eighth information D8-1 to D8-p may be referred to as eighth information D8. In the shown example, p is 85. The eighth information D8-j may be referred to as aj-th set of eighth information D8. Here, j is an integer of 1 or more and p or less. The header area includes type information (typeID). The type information is identification information for identifying the effect information DE1 and the effect information DE2. Since the other items in the header area of the effect information DE1 are common to the items in the profile information DP1, detailed descriptions thereof will be omitted.

The p sets of eighth information D8 are information indicating a brightness applied to two or more light sources 17a among the plurality of light sources 17a, and indicate a gain in driving of the light sources 17a. Accordingly, the brightness of the two or more light sources 17a among the plurality of light sources 17a can be adjusted based on the eighth information D8. The eighth information D8 may be expressed as data in the form of a tone value, a control value for driving, or a coefficient used to calculate a control value for driving.

When p is 2 or more as in the embodiment, the p sets of eighth information D8 each indicate a different brightness. In this way, in the embodiment, p is 2 or more, and the p sets of eighth information D8 include the first set of eighth information D8-1 and the second set of eighth information D8-2 that is at least partially different from the first set of eighth information D8. Accordingly, the brightness of the two or more light sources 17a among the plurality of light sources 17a can be adjusted to a brightness indicated by the first set of eighth information D8 or a brightness indicated by the second set of eighth information D8.

The ninth information D9 indicates time (time) from a start of execution of the first set to an end of execution of the p-th set of eighth information D8. Accordingly, an execution time of the p sets of eighth information D8 can be adjusted based on the ninth information D9.

FIG. 13 shows a gain based on the eighth information D8 and the ninth information D9. In FIG. 13, a horizontal axis represents time, and a vertical axis represents a tone indicated by the eighth information D8. As shown in FIG. 13, by controlling the brightness of the light sources 17a at tones indicated by the p sets of eighth information D8 over time T indicated by the ninth information D9, the brightness of the light sources 17a can be adjusted such that the brightness changes in time-series. In the embodiment, the eighth information D8 includes data in which the gain increases from the first set of eighth information D8-1 to the p-th set of eighth information D8-p. Therefore, when the first set of eighth information D8-1 to the p-th set of eighth information D8-p are applied in ascending order, a graph is obtained in which the brightness increases over time, as shown in FIG. 13. When applying in descending order from the eighth information D8-p, the brightness decreases over time. Therefore, the brightness of the light sources 17a can be adjusted to fade in or fade out. That is, a blinking effect of the light sources 17a can be performed. Whether to fade in or fade out may be determined by specifying a reading order of the eighth information D8. By reading the eighth information D8 in ascending order and then reading in descending order, it is also possible to perform an effect of repeating fade-in and fade-out. In this way, the brightness of the plurality of light sources 17a can be changed according to data content of the eighth information D8 and the reading order.

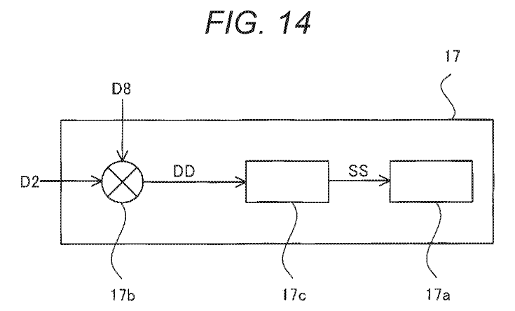

FIG. 14 shows driving of the light sources 17a. As shown in FIG. 14, each light source 17a is driven by a drive signal SS output from a drive circuit 17c provided in the illuminator 17. The drive signal SS is a current signal. The drive circuit 17c is a circuit that generates the drive signal SS based on control signal DD from an arithmetic circuit 17b, and generates the drive signal SS by adjusting a current from a power supply (not shown) based on the control signal DD. The control signal DD is a digital signal. The arithmetic circuit 17b is a circuit that generates the control signal DD based on the eighth information D8 and the ninth information D9. More specifically, the arithmetic circuit 17b generates the control signal DD using processing of multiplying a control value for emitting light in a color indicated by the second information D2 by a control value for emitting light in a brightness indicated by the p sets of eighth information D8. Therefore, the control signal DD indicates a product of these control values. The drive signal SS is a signal based on the product of these control values.

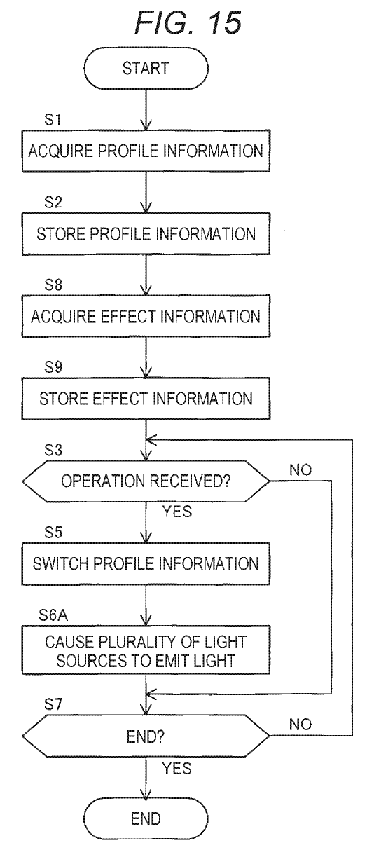

FIG. 15 is a flowchart showing a flow of the illumination control method according to the second embodiment. The illumination control method of the embodiment is the same as the illumination control method of the first embodiment except that step S6A is provided instead of step S6 of the first embodiment and steps S8 and S9 are added.

In the embodiment, after step S2, in step S8, the processing device 12 acquires the effect information DE1 and DE2. More specifically, in step S8, the processing device 12 functioning as the illumination controller 12c acquires the effect information DE1 and DE2 by receiving the effect information DE1 and DE2 from the terminal apparatus 30A via the communication device 13. Step S8 may be performed simultaneously with step S1 or before step S1.

After step S8, in step S9, the processing device 12 stores the effect information DE1 and DE2. More specifically, in step S9, the processing device 12 functioning as the illumination controller 12c stores the received effect information DE1 and DE2 in the storage device 11. Step S9 may be performed simultaneously with step S2 or before steps S1 and S2 as long as step S9 is performed after step S8.

After step S9, the processing device 12 proceeds to step S3.

When the input device 16 receives an operation (step S3: YES), after step S5, in step S6A, the processing device 12 functioning as the illumination controller 12c causes the plurality of light sources 17a to emit light in a light emission pattern and a light emission color based on the combination of the profile information DP1 or the profile information DP2 and the effect information DE1 or the effect information DE2.

Here, causing each of the plurality of light sources 17a to emit light in step S6A includes causing each of the plurality of light sources 17a to emit light in a color determined according to a combination of the p sets of eighth information D8 and the second information D2. Accordingly, each of the plurality of light sources 17a can be caused to emit light in the color determined according to the combination of the eighth information D8 and the second information D2.

Causing each of the plurality of light sources 17a to emit light in step S6A includes driving each of the plurality of light sources 17a by the drive signal SS. As described above, the drive signal SS is a signal based on the product of the control value for emitting light in the color indicated by the second information D2 and the control value for emitting light in the brightness indicated by the p sets of eighth information D8. Accordingly, each of the plurality of light sources 17a can be caused to emit light in the color determined according to the combination of the eighth information D8 and the second information D2.

Further, causing each of the plurality of light sources 17a to emit light in step S6A includes one or both of causing each of the plurality of light sources 17a to emit light using the p sets of eighth information D8 in order from the first set of eighth information D8 and causing each of the plurality of light sources 17a to emit light using the p sets of eighth information D8 in order from the p-th set of eighth information D8. Accordingly, the brightness of the light sources 17a can be adjusted such that the brightness changes in time-series. For example, the brightness of the plurality of light sources 17a can be faded in or faded out, or the light emission pattern of the plurality of light sources 17a can be repeated.

### 3. Modification

Each aspect shown as examples above can be variously modified. Specific aspects of modifications applicable to each aspect described above are shown below as examples. Two or more aspects optionally selected from the following examples can be combined as appropriate to an extent that no contradiction occurs.

### 3-1. Modification 1

The profile information DP1 may include a plurality of pieces of first information D1 indicating different colors or different numbers of colors. In this case, among the plurality of pieces of first information D1, any one piece of first information D1 is an example of a "first set of first information", and any other piece of first information D1 is an example of a "second set of first information". In this way, when the profile information DP1 includes the plurality of pieces of first information D1 indicating different colors or different numbers of colors, the light emission pattern and the light emission color of the plurality of light sources 17a may be switched by selecting and using any of the plurality of pieces of first information D1. In this case, even when the same n sets of second information D2 are used without switching between the profile information DP1 and the profile information DP2, light emission patterns having different light emission colors can be implemented.

### 3-2. Modification 2

In the embodiment described above, an aspect in which the illumination apparatus 10 has the projection function in addition to the illumination function is shown as an example, but the disclosure is not limited to this aspect, and the data structure of the disclosure is applicable to various apparatuses including a plurality of light sources that can change light emission colors, for example, illumination light and a light-emitting diode (LED) band.

The data structures DS1 and DS2 described above can be reused even when a light source device to be caused to emit light is changed. In this case, for example, even when a light source drive circuit is required to be changed, a circuit that generates a light source control signal based on the data structures DS1 and DS2 can be reused.

Further, even when the number of light sources to be caused to emit light is changed, content of the data structures DS1 and DS2 may be changed according to the number and disposition of the light sources, which is more convenient than an aspect in which light source light emission control is performed by programming.

### 3-3. Modification 3

In the embodiment described above, an aspect in which the terminal apparatus 30 performs the setting and control of one illumination apparatus 10 is shown as an example, but the present disclosure is not limited to this aspect, and the terminal apparatus 30 may perform the setting and control of a plurality of illumination apparatuses 10.

### 3-4. Modification 4

The programs PR1 and PR2 in the embodiment described above may be provided in a state of being recorded on a computer-readable non-transitory recording medium. Alternatively, the programs PR1 and PR2 in the embodiment described above may be provided in a form of being downloaded from a server to the computer through a network.

### 4. Appendices

The disclosure will be summarized below as appendices.

(Appendix 1) Appendix 1 that is a preferred example of a data structure according to the disclosure includes: first information including information indicating a plurality of colors different from each other; and n sets of second information associating any one of the plurality of colors indicated by the first information with each of a plurality of light sources of an illumination apparatus, n being an integer of 1 or more. In the above aspect, when the data structure is applied to the illumination apparatus, each of the plurality of light sources can be caused to emit light in a color corresponding to content of the first information and the second information, and thus it is possible to implement highly versatile light source control corresponding to various lighting modes.

(Appendix 2) In Appendix 2 that is a preferred example of Appendix 1, each of the plurality of light sources includes a first light-emitting element that emits light having a first wavelength and a second light-emitting element that emits light having a second wavelength different from the first wavelength, the first information includes, for each of the plurality of light sources, first brightness information indicating a brightness of the first light-emitting element and second brightness information indicating a brightness of the second light-emitting element, and a combination of the first brightness information and the second brightness information indicates any one of the plurality of colors. In the above aspect, since the brightness of the first light-emitting element and the brightness of the second light-emitting element can be indicated by each of the first brightness information and the second brightness information, when the data structure is applied to the illumination apparatus, each light source can be caused to emit light in a plurality of colors by a combination thereof.

(Appendix 3) In Appendix 3 that is a preferred example of Appendix 1 or Appendix 2, n is 2 or more, and an (m + 1)-th set of the second information among the n sets of the second information is stored in a data area read subsequently to an m-th set of the second information, where m is an integer of 1 or more and n - 1 or less. In the above aspect, since the (m + 1)-th set of second information can be read following the m-th set of second information, it is possible to execute light source light emission control using the m-th set of second information and the (m + 1)-th set of second information in order.

(Appendix 4) Appendix 4 that is a preferred example of any one of Appendix 1 to Appendix 3 further includes: fourth information indicating a value of n. In the above aspect, the value of n can be easily determined based on the fourth information. Since a common data structure can be applied even when the value of n is different, versatility is high.

(Appendix 5) Appendix 5 that is a preferred example of Appendix 4 further includes: fifth information indicating whether to repeatedly execute processing of reading the n sets of the second information in order from a first set to an n-th set. In the above aspect, it is possible to determine whether the processing of reading the n sets of second information is repeated based on the fifth information. Since a common data structure can be applied regardless of whether the repetition is performed, versatility is high.

(Appendix 6) Appendix 6 that is a preferred example of any one of Appendix 1 to Appendix 5 further includes: sixth information indicating a number of sets of the second information to be applied per unit time among the n sets of the second information. In the above aspect, the number of sets of second information to be applied per unit time can be determined based on the sixth information. Since a common data structure can be applied even when the number of sets is different, versatility is high.

(Appendix 7) In Appendix 7 that is a preferred example of any one of Appendix 1 to Appendix 6, the first information is a first set of the first information, and the data structure further includes a second set of the first information that differs from the first set of the first information in at least a color or a number of colors. In the above aspect, the plurality of light sources can be controlled with different light emission colors based on the first set of first information and the second set of first information having the common data structure. Therefore, it is possible to implement more versatile light source control than when an individual control command is prepared for each light emission mode.

(Appendix 8) Appendix 8 that is a preferred example of any one of Appendix 1 to Appendix 7 further includes: seventh information indicating a number of the plurality of light sources. In the above aspect, the number of the plurality of light sources can be determined based on the seventh information. Since a common data structure can be applied even when the number is different, versatility is high.

(Appendix 9) Appendix 9 that is a preferred example of any one of Appendix 1 to Appendix 8 further includes: p sets of eighth information indicating a brightness applied to two or more light sources among the plurality of light sources, p being an integer of 1 or more. In the above aspect, when the data structure is applied to the illumination apparatus, the brightness of the two or more light sources among the plurality of light sources can be adjusted based on the eighth information, and thus more various lighting modes can be implemented.

(Appendix 10) Appendix 10 that is a preferred example of Appendix 9 further includes: ninth information indicating time from a start of execution of a first set to an end of execution of a p-th set of the p sets of the eighth information. In the above aspect, since the execution time of the p sets of eighth information can be adjusted based on the ninth information, more various lighting modes can be implemented.

(Appendix 11) In Appendix 11 that is a preferred example of Appendix 9 or Appendix 10, p is 2 or more, and the p sets of the eighth information include a first set of the eighth information, and a second set of the eighth information at least partially different from the first set of the eighth information. In the above aspect, since the brightness of the two or more light sources among the plurality of light sources can be adjusted to a brightness indicated by the first set of eighth information or a brightness indicated by the second set of eighth information, more various lighting modes can be implemented.

(Appendix 12) Appendix 12 that is a preferred example of any one of Appendix 1 to Appendix 11 further includes: third information indicating a number of colors in the first information. In the above aspect, the number of colors in the first information can be easily determined based on the third information. Since a common data structure can be applied even when the number is different, versatility is high.

(Appendix 13) Appendix 13 that is a preferred example of an illumination control method according to the disclosure includes: causing each of a plurality of light sources of an illumination apparatus to emit light based on first information including information indicating a plurality of colors different from each other, and n sets of second information associating any one of the plurality of colors indicated by the first information with each of the plurality of light sources, n being an integer of 1 or more. In the above aspect, it is possible to implement highly versatile light source control corresponding to various lighting modes.

(Appendix 14) In Appendix 14 that is a preferred example of Appendix 13, causing each of the plurality of light sources to emit light includes causing each of the plurality of light sources to emit light in a color determined according to a combination of the second information and p sets of eighth information indicating a brightness applied to two or more light sources among the plurality of light sources, p being an integer of 1 or more. In the above aspect, each of the plurality of light sources can be caused to emit light in the color determined according to the combination of the eighth information and the second information.

(Appendix 15) In Appendix 15 that is a preferred example of Appendix 14, causing each of the plurality of light sources to emit light includes driving each of the plurality of light sources by a drive signal based on a product of a control value for emitting light in the color indicated by the second information and a control value for emitting light in the brightness indicated by the p sets of the eighth information. In the above aspect, each of the plurality of light sources can be caused to emit light in the color determined according to the combination of the eighth information and the second information.

(Appendix 16) In Appendix 16 that is a preferred example of Appendix 14 or Appendix 15, causing each of the plurality of light sources to emit light includes one or both of causing each of the plurality of light sources to emit light using the p sets of the eighth information in order from a first set of the eighth information, and causing each of the plurality of light sources to emit light using the p sets of eighth information in order from a p-th set of the eighth information. In the above aspect, the brightness of the plurality of light sources can be changed over time according to an order in which the p sets of eighth information are applied. Even when the eighth information is not prepared for each method of changing the brightness of the plurality of light sources, more various light emission modes can be implemented.

(Appendix 17) Appendix 17 that is a preferred example of an illumination apparatus according to the disclosure includes: a plurality of light sources; and a control device configured to cause each of the plurality of light sources to emit light based on first information including information indicating a plurality of colors different from each other, and n sets of second information associating any one of the plurality of colors indicated by the first information with each of the plurality of light sources, n being an integer of 1 or more. In the above aspect, it is possible to implement highly versatile light source control corresponding to various lighting modes.

What is claimed is:

1. A data structure comprising:
first information including information indicating a plurality of colors different from each other; and
n sets of second information associating any one of the plurality of colors indicated by the first information with each of a plurality of light sources of an illumination apparatus, n being an integer of 1 or more.

2. The data structure according to claim 1, wherein
each of the plurality of light sources includes a first light-emitting element that emits light having a first wavelength and a second light-emitting element that emits light having a second wavelength different from the first wavelength,
the first information includes, for each of the plurality of light sources, first brightness information indicating a brightness of the first light-emitting element and second brightness information indicating a brightness of the second light-emitting element, and
a combination of the first brightness information and the second brightness information indicates any one of the plurality of colors.

3. The data structure according to claim 1, wherein
n is 2 or more, and
an (m + 1)-th set of the second information among the n sets of the second information is stored in a data area read subsequently to an m-th set of the second information, where m is an integer of 1 or more and n - 1 or less.

4. The data structure according to claim 1, further comprising:
fourth information indicating a value of n.

5. The data structure according to claim 4, further comprising:
fifth information indicating whether to repeatedly execute processing of reading the n sets of the second information in order from a first set to an n-th set.

6. The data structure according to claim 1, further comprising:
sixth information indicating a number of sets of the second information to be applied per unit time among the n sets of the second information.

7. The data structure according to claim 1, wherein
the first information is a first set of the first information, and
the data structure further comprises a second set of the first information that differs from the first set of the first information in at least a color or a number of colors.

8. The data structure according to claim 1, further comprising:
seventh information indicating a number of the plurality of light sources.

9. The data structure according to claim 1, further comprising:
p sets of eighth information indicating a brightness applied to two or more light sources among the plurality of light sources, p being an integer of 1 or more.

10. The data structure according to claim 9, further comprising:
ninth information indicating time from a start of execution of a first set to an end of execution of a p-th set of the p sets of the eighth information.

11. The data structure according to claim 9, wherein
p is 2 or more, and
the p sets of the eighth information include
a first set of the eighth information, and
a second set of the eighth information at least partially different from the first set of the eighth information.

12. The data structure according to claim 1, further comprising:
third information indicating a number of colors in the first information.

13. An illumination control method comprising:
causing each of a plurality of light sources of an illumination apparatus to emit light based on first information including information indicating a plurality of colors different from each other, and n sets of second information associating any one of the plurality of colors indicated by the first information with each of the plurality of light sources, n being an integer of 1 or more.

14. The illumination control method according to claim 13, wherein
causing each of the plurality of light sources to emit light includes causing each of the plurality of light sources to emit light in a color determined according to a combination of the second information and p sets of eighth information indicating a brightness applied to two or more light sources among the plurality of light sources, p being an integer of 1 or more.

15. The illumination control method according to claim 14, wherein
causing each of the plurality of light sources to emit light includes driving each of the plurality of light sources by a drive signal based on a product of a control value for emitting light in the color indicated by the second information and a control value for emitting light in the brightness indicated by the p sets of the eighth information.

16. The illumination control method according to claim 14, wherein
causing each of the plurality of light sources to emit light includes one or both of
causing each of the plurality of light sources to emit light using the p sets of the eighth information in order from a first set of the eighth information, and
causing each of the plurality of light sources to emit light using the p sets of eighth information in order from a p-th set of the eighth information.

17. An illumination apparatus comprising:
a plurality of light sources; and
a control device configured to cause each of the plurality of light sources to emit light based on first information including information indicating a plurality of colors different from each other, and n sets of second information associating any one of the plurality of colors indicated by the first information with each of the plurality of light sources, n being an integer of 1 or more.
